(19) United States
(12) Patent Application Publication
(10) Pub. No.: US 2004/0008626 A1
(43) Pub. Date: Jan. 15, 2004

(54) Mechanism for transmission of time-synchronous data

(76) Inventors: Andreas Schrader, Heidelberg (DE); Darren Carlson, Heidelberg (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/603,749

(22) Filed: Jun. 26, 2003

(30) Foreign Application Priority Data
Jun. 27, 2002 (DE) 10228861.5

(51) Int. Cl. H04L 1/00

(52) U.S. Cl. 370/232; 370/252

(57) ABSTRACT

A mechanism for the transmission of time-synchronous data from a sender to a receiver using a network, in particular the Internet, where the data is processed and/or transmitted at the sender as well as the receiver side using at least one processing unit. The mechanism is designed in such a way, that for improving the transmission quality for time-synchronous data a parallel processing unit is setup and/or adapted based on changed data load and/or network characteristics. After a switching process, preferably using a switch, the data is processed and/or transmitted using the parallel processing unit.

The present application claims priority to prior German application DE 102 28 861.5, the disclosure of which is incorporated herein by reference.

### BACKGROUND OF THE INVENTION

This invention covers a mechanism for the transmission of time-synchronous data from sender to receiver using a network, especially the Internet, where the data is processed and/or transmitted with at least one processing unit at the sender and/or the receiver. A processing unit might be realized in hardware or software or a combination of both and can contain several subcomponents for filtering, processing, compressing, packetizing of data, etc. The mechanism in this invention is independent of the actual type of processing elements.

Mechanisms for the transmission of time-synchronous data are well-known in practice and are very well suited for the transmission of multimedia purposes, like video conferences, telephone calls and others. This is especially true in the context of transmitting data over IP networks—Internet Protocol networks. The most common networks are usually only configured for the transmission of scalable, time-insensitive applications, like e.g. Internet-Browsing. Due to their intrinsic structure, these networks are not well suited for the transmission of time-synchronous data. Therefore significant disturbance of the transmission can be observed inside known networks. This leads to partially unacceptable degradation of transmission quality.

To improve the transmission quality, mechanisms have been developed, which allow for the transmission of time-synchronous data, especially multimedia data, in real-time. The goal of these mechanisms is to improve the QoS—Quality of Service—by treating time-synchronous data with a higher priority for transmission than other traffic. Time-synchronous data is therefore transmitted with a higher probability than other data. One of the disadvantages of these mechanisms is the inability to cover from transmission disturbance of time-synchronous data caused by fluctuations of network transmission characteristics.

This is especially true for fluctuations in network parameters due to physical limitations, especially in the case of wireless networks.

The transmission of time-synchronous data, which are most often transmitted in a compressed format, is especially difficult, since the data must be available at the receiver at a precise time in order to allow for timely proper decoding and rendering. Data arriving after the foreseen playback time is often useless and must be discarded. Likewise, data arriving in advance of its playback time may overtax the receiver's memory capabilities. In the extreme case, the receiver's memory capabilities are exceeded, causing data loss. In either case, data loss or delay has detrimental effects on the transmission quality, such that the overall transmission is partially useless.

Especially in wireless networks due to the intrinsic physical limitations, IP packets can get lost, leading to a significant degradation of media quality. In opposite to the transmission over copper or fiber cables, losses actually happen more often. This so called burst characteristic of wireless networks has especially detrimental effects.

Some known mechanisms use monitoring of network characteristics to avoid overload of networks by adapting the transmission and/or data reception. Examples are adaptive audio-/video senders, which can adapt their streaming behavior based on monitoring results. The adaptation of the streaming process is mainly based on the adaptation of the processing unit to the changed network characteristics. Most often, this is based on a modification of the compression method used in the processing unit. To allow for adaptation, the processing unit must be de-attached, adapted and re-attached. De-attaching in this context means to stop data delivery to this unit to avoid unprocessed data. Re-attaching means to re-establish the data flow to this entity by some appropriate mechanism (e.g. modifying pointer values to the entity and to re-establish the cycle of data processing function calls at this element). This leads to further problems in the transmission quality due to this time consuming process, where processing and transmission of data is impossible or with additional delay. This leads again to significant degradation of transmission quality of time-synchronous data as described above.

FIG. 1 shows an embodiment of a known mechanism for the transmission of time-synchronous data from a sender 1′ to a receiver 2′ over a network. The data is processed and transmitted at the sender side using the processing unit 3′. The network characteristics are changing and therefore, the processing unit 3′ is not any more suited to process the data, e.g. to compress and to divide the data into packets, such that a sufficient transmission quality can be achieved at the receiver. In this example, the data represent raw video frames at a frame rate f [1/s].

In FIG. 2 the respective time order of the embodiment of FIG. 1 is shown. Sender 1′ produces data as unprocessed synchronized video frames with frame rate f [1/s]. The raw frames are passed to the processing unit 3′ and have length Δt=1/f. The frames are therefore passed to the processing unit 3′ at synchronous times {t₀, t₀+Δt, t₀+2 Δt, . . .}. The time, necessary to construct processing unit 3′ with a codec 6a′, a filter 6b′, and a packetizer 6c′ as well as all other required resources is denoted as σ₁.

At time t₀ the processing unit 3′ is ready for transmission and the first frame 1 will be processed and transmitted. The intrinsic delay of processing unit 3′ is denoted as δ₁. This denotes the time required inside processing unit 3′ to process 1 frame and to produce data output. Intrinsic delay can be observed for example in modern video codecs, which mode of inter-frame processing is based on the so-called GOP—Group of Picture. A GOP consists of different image types, where B-frames—bi-directional frames—are only processed and played, if a previous or following I-frame—intra-coded frame—is available in the internal buffer. Typical GOPs like for example in the MPEG format, consist of nine frames, e.g. IBBPBBPBB. The output of data through the processing unit 3′ is therefore only possible at times {t₀+δ₁, t₀+δ₁+Δt, t₀+Δ₁+2Δt, . . .}.

In general, a data management system will be involved in the transmission, which generates the trigger event at time tᵣ. In this embodiment, the trigger event is generated during the output of data for frame number i. The output of all data of this frame will be continued and finished, before the processing unit 3′ completely stops the processing and transmission of data. The invention is independent of the actual mechanism for the generation of this trigger (e.g. interrupt signals or method calls).

The time necessary to release all required resources of processing unit 3′ is denoted as φᵢ. The releasing process is therefore finished at time t₀+δ₁+iΔt+φᵢ. Now, a new processing unit 3″ is assembled, which requires σ₂ seconds. Under the assumption, that the data processing within processing unit 3″ can not be performed faster than real-time, this leads to the fact, that the processing of frames can only be started after the input of a complete frame. Therefore, the next frame after finishing the creation process of the new processing unit 3″ is frame number j. The time until frame j is completely available is denoted as resync gap. The processing unit 3″ starts the processing of the input data data at time t₀′ and the transmission of the first processed at time t₀′+δ₂ due to the intrinsic delay σ₂. This means, that during the time period t_{γ}=[t₀+δ₁+iΔt, t₀′+σ₂] no data output can be generated. This time period is donated as gap time t_{γ}.

The time when the new processing unit 3″ is starting can be computed as

$$\begin{matrix}{t}_{0}^{′} = {t}_{0} + [ \frac{{δ}_{1} + i Δ t + {Φ}_{1} + {σ}_{2}}{Δ t} ] Δ t \\ = {t}_{0} + [ i + \frac{{δ}_{1} + {Φ}_{1} + {σ}_{2}}{Δ t} ] Δ t\end{matrix}$$

With t₀′=t₀+(j−1)Δt the first frame, that can be delivered from the new processing unit 3″ can be computed.

$$j = i + [ \frac{{δ}_{1} + {Φ}_{1} + {σ}_{2}}{Δ t} ] + 1$$

For the lost time t_{λ} the following is true

$$\begin{matrix}{t}_{λ} = ( j - 1 ) Δ t - i Δ t \\ = [ \frac{{δ}_{1} + {Φ}_{1} + {σ}_{2}}{Δ t} ] Δ t\end{matrix}$$

With this, the number λ of unprocessed frames during this time period can be computed as

$$\begin{matrix}λ = j - 1 - i \\ = [ \frac{{δ}_{1} + {Φ}_{1} + {σ}_{2}}{Δ t} ]\end{matrix}$$

The gap time t_{γ} is the time, where no data is produced at the output during the adaptation:

$$\begin{matrix}{t}_{γ} = {t}_{0}^{′} + {δ}_{2} - ( {t}_{0} + {δ}_{1} + i Δ t ) \\ = {t}_{0} + [ i \frac{{δ}_{1} + {Φ}_{1} + {σ}_{2}}{Δ t} ] Δ t + {δ}_{2} - {t}_{0} - {δ}_{1} - i Δ t \\ = [ \frac{{δ}_{1} + {Φ}_{1} + {σ}_{2}}{Δ t} ] Δ t + ( {δ}_{2} - {δ}_{1} )\end{matrix}$$

In the known mechanism, t_{α} is the time needed to fulfill the requested adaptation. It is exactly equivalent to the gap time t_{γ}:

t_{α}=t_{γ}

### SUMMARY OF THE INVENTION

According to the invention the goal described above is achieved with the mechanism for transmission of time-synchronous data, which attributes are described in patent claim 1. According to that claim, the mechanism is built and extended in such a way, that a parallel processing unit is setup and/or adapted based on changed data load and/or network characteristics. Here, setup means to instantiate and initialize the respective subcomponents of the processing unit. Adapting means configuring or changing attribute parameters of the involved subcomponents (e.g. quantization matrix of a compressor or packet length of a packetizer). Initializing means to reserve the necessary resources (e.g. memory) and to bring the component in a state which is ready to perform tasks. The processing and/or transmission of data in this parallel processing unit is performed after switching to that parallel unit, preferably using a switch.

According to the invention it has been observed, that in opposition to the common practice, a good transmission quality can not be achieved by only adapting the used data compression scheme to the changed data load and/or network characteristics. Instead, to achieve an overall high quality transmission, transmission quality has also to be ensured during the adaptation. In addition it has been observed, that the adaptation to changed data load and/or network characteristics has to be performed independently of the current used processing and/or transmitting unit. This is necessary to ensure, that no further degradations of transmission quality is caused by the adaptation process itself. According to the invention this is achieved through the setup of a parallel processing unit, which is adapted to the changed data load and/or network characteristics. This avoids completely any losses during the de-attaching, adaptation, and re-attaching of the processing unit, since the data processing and transmission is continued within the original processing unit during the setup and/or adaptation of the parallel processing unit. Only afterwards the parallel processing unit is connected, preferable using a switch, such that the processing and/or transmission of data is performed within the parallel processing unit. This ensures a high transmission quality also during the adaptation and therefore improves the overall transmission quality during situations with changing data load and/or network characteristics. With processing, any kind of means for modification, processing, storing or any other kind of data-related actions is included. The switch can hereby be realized as hardware or software.

To allow for a simplified embodiment, the setup and/or adaptation of the parallel processing unit can be started with a trigger event. For the sender side setup of the parallel processing unit, such a trigger event can be generated through any kind of appropriate existing means, e.g. “trading algorithm”, statistical feedback information or “application level signaling”. For the receiver side setup of the parallel processing unit, the trigger event can be generated for example through in-band signaling methods, e.g. through RTP payload numbers—Realtime Transport Protocol payload numbers—or similar mechanisms. Also it is possible to generate the trigger event at sender and receiver in the same way.

In the context of an again very simple embodiment, the switching process could be performed after a completed setup and/or adaptation of the parallel processing unit. The data, which is produced in the parallel processing unit could then be transmitted over the network or directly to the receiver.

In addition or alternatively, the switching could be performed after a certain switching condition is fulfilled, especially if at least one given parameter value is reached. These parameters could for example describe the data rate produced and/or certain network parameters or similar parameters. But also any other kind of condition could be used for the switching. The use of such a switching condition could be very advantageous in that a further initialization of the processing unit and/or parallel processing unit could be performed without disturbing the data transmission. This would be especially useful if such codecs—compressor/decompressor—are used, that produce initially a higher data rate than in the normal mode.

In a special advantageous way, data could be processed in the processing unit using different subcomponents, especially at least one codec and/or at least one filter and/or at least one packetizer and/or at least one memory buffer or similar components. This would allow for optimal processing and transmission of data through the processing unit.

In a further special advantageous way, data could be processed in the parallel processing unit using different subcomponents, especially at least one codec and/or at least one filter and/or at least one packetizer and/or at least one memory buffer or similar components. This would allow for optimal processing and transmission of data through the parallel processing unit.

The subcomponents could be attached to each other in a preferred way, preferably during the setup. This allows for the processing and/or transmission of data through the subcomponents and therefore through the processing unit and/or the parallel processing unit.

In a further advantageous way, the processing unit and/or the parallel processing unit could be initialized, preferably after the setup. During the initialization, internal data structures could be initialized’ and/or necessary resources could be requested from the processing unit and/or the parallel processing unit, which would prepare the processing unit and/or parallel processing unit to be ready for processing. Through a premature initialization of the parallel processing unit, an overall increased adaptation could also be achieved.

To achieve a particular good adaptation, the subcomponents of the parallel processing unit could be tuned to each other and/or the changed data load and/or network characteristic. In particular the compression method used in the codec could be adjusted to the changed network characteristic. Additionally or alternatively, also for example the memory buffer could be increased or decreased, to allow for tuning the parallel processing unit to the changed network characteristics. Also, the packetizer could be adapted to the changed network characteristic, which divides data into packets to prepare them to be send using RTP streaming or any other appropriate streaming protocol.

In order to allow for particular good exploitation of resources, the subcomponents of the processing unit could be de-attached after switching. This would be beneficial, since the bound resources of the processing unit could be offered to the system again.

Alternatively, the subcomponents of the processing unit could also remain connected after switching. For example, this could be realized in a way, that the processing unit is only maintained a certain period of time after switching. This would mean, that the subcomponents of the processing unit would only be connected during a certain period of time. This could be particular advantageous, if enough resources are available in the system, and there exists a high probability, that the next trigger event will require to use the original processing unit again. If the original processing unit is used again, the parallel processing unit could be treated in the same way as the processing unit after switching.

To allow for a particular high efficiency, additional parallel processing units could be setup and/or adapted based on changed data load and/or network characteristic. This would be especially advantageous for hierarchical compression schemes with several synchronized data stream, since they could then be adapted in parallel. If enough resources are available in the system, it could also be possible to maintain a complete set of parallel processing units, such that the adaptation to changed data load and/or network characteristics could be based on choosing one of the already synchronized parallel processing units.

To allow for a particular good adaption of the mechanism to varying conditions in the network, at least one further processing unit for transmission and/or processing of the data could be used sequentially in addition to the processing unit and/or parallel processing unit. This additional processing unit would allow for optimizing the transmission of data to two independent receivers. For example for one receiver with comprehensive resource equipment, e.g. a multimedia workstation, and one receiver with restricted resources, e.g. a laptop.

In a further advantageous way, the data could be grasped using sensor equipment (e.g. camera, microphone) for visual data, speech and other media types. This would enable the mechanism to be especially suited for video conferences over the Internet, Internet Telephony and similar applications.

Actually, various possibilities exist for the design of the idea of this invention to be implemented and developed further. For this it is referred to the patent claims listed after patent claim 1 as well as to the following explanation of a preferred embodiment example of the invented mechanism for the transmission of time-synchronous data as outlined in the drawing. In combination with the explanation of a preferred embodiment of the invented mechanism using the drawing, commonly preferred variations and further developments of the idea will be explained.

The goal of this invention is therefore to describe a mechanism for the transmission of time-synchronous data as described above, which allows for improving the transmission quality of time-synchronous data in the case of varying data load and/or network characteristics.

### BRIEF DESCRIPTION OF THE DRAWINGS

FIG. 1 shows a schematic presentation of an embodiment of a known mechanism,

FIG. 2 shows in a schematic presentation the time order of events of the known mechanism according to the embodiment of FIG. 1,

FIG. 3 shows a schematic presentation of an embodiment of the invention idea, and

FIG. 4 shows in a schematic drawing the time order of events of the invented mechanism according to the embodiment of FIG. 3.

### DESCRIPTION OF THE PREFERRED EMBODIMENTS

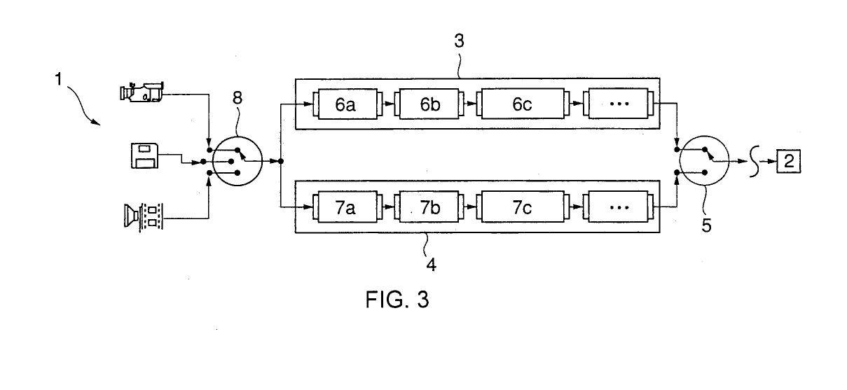

FIG. 3 shows a schematic presentation of an embodiment of the mechanism according to the invention for the transmission of time-synchronous data from a sender 1 to a receiver 2 over a network. The data is processed and transmitted at the sender side using the processing unit 3. The network characteristics are changing and therefore, the processing unit 3 is not any more suited to process the data, e.g. to compress and to divide the data into packets, that a sufficient transmission quality can be achieved at the receiver. In this example, the data represent raw video frames at a frame rate f[1/s].

According to the invention a new processing unit 4 is setup, which is adapted to the new conditions. The schematic drawing in FIG. 3 shows the embodiment before switching using the switch 5, such that the processing and transmission of data at that time is performed within processing unit 3.

In the embodiment of FIG. 3, the data is processed using various subcomponents 6a, 6b, 6c within processing unit 3. In particular, these subcomponents are a codec 6a for the compression of data, a filter 6b for the eventually removing of frames, as well as a packetizer 6c for dividing the data into packets for streaming (e.g. via RTP). In an analogous way, the data is processed in processing unit 4 using various subcomponents 7a, 7b, 7c. Also here, the subcomponents 7a, 7b, and 7c are a codec 7a, a filter 7b, and a packetizer 7c.

Within processing unit 3 as well as within the parallel processing unit 4, additional not shown subcomponents for further processing and transmission of frames are foreseen.

The data from sender 1 in this example is acquired using a mechanism for capturing visual data, a video camera, and will be forwarded to the processing unit 3, as well as to processing unit 4 after their creation, using an additional switch 8.

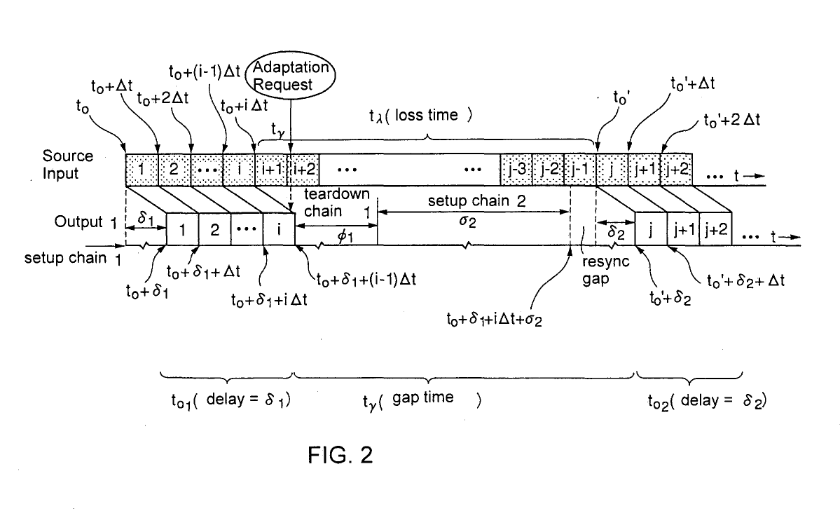

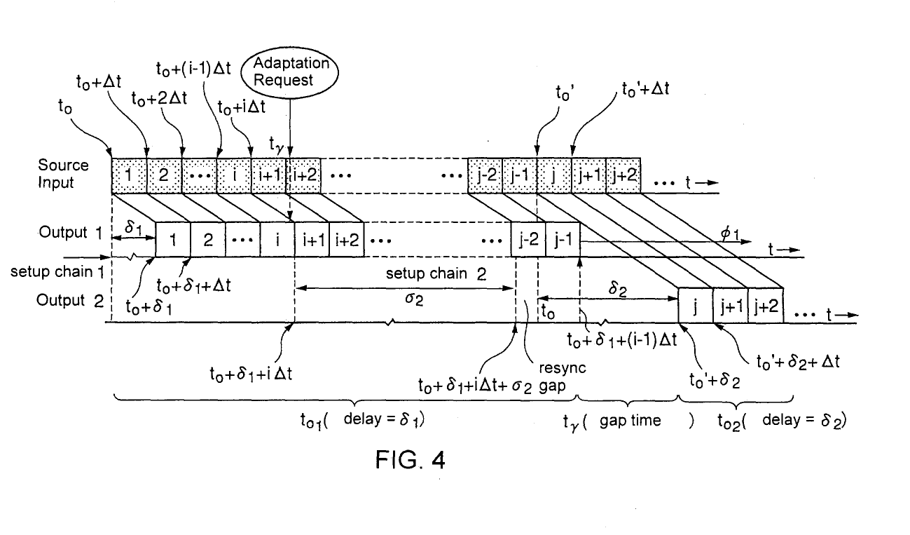

FIG. 4 shows the time schedule of the mechanism according to the invention under the same pre-conditions as in the embodiment of FIG. 2. Equivalent times and data are denoted with the same notations. After time t₀, again a trigger event is generated within the data management system. The time to generate the parallel processing unit is again denoted as time σ₂.

Whereas the processing unit 4 is created within the time σ₂, processing unit 3 is processing and transmitting frames, in particular frames up to frame number j−1. Afterwards, the switching is performed using the switch 5, such that the parallel processing unit 4 is processing frame number j and no frames get lost. The time, when the parallel processing unit 4 is ready to transmit frames, can be therefore be computed as t₀

$$\begin{matrix}{t}_{0}^{′} = {t}_{0} + [ \frac{{δ}_{1} + i Δ t + {σ}_{2}}{Δ t} ] Δ t \\ = {t}_{0} + [ i + \frac{{δ}_{1} + {σ}_{2}}{Δ t} ] Δ t\end{matrix}$$

Under the assumption, that t₀′=t₀+(j−1)Δt, the first output is

$$j = i + [ \frac{{δ}_{1} + {σ}_{2}}{Δ t} ] + 1$$

and the gap time t_{γ} can be determined as follows

$$\begin{matrix}{t}_{γ} = {t}_{0}^{′} + {δ}_{2} - ( {t}_{0} + {δ}_{1} + ( j - 1 ) Δ t ) \\ = {t}_{0} + ( j - 1 ) Δ t + {δ}_{2} - ( {t}_{0} + {δ}_{1} + ( j - 1 ) Δ t ) \\ = ( {δ}_{2} - {δ}_{1} )\end{matrix}$$

If δ₂ is greater than δ₁, a transmission break will occur, which can be compensated by using a memory buffer. Such memory buffers are already in use for the compensation of jitter and therefore no additional resources are required. The transmission break is actually only caused by the difference of the intrinsic delays of the involved codecs and is not created by the mechanism according to the invention. In any case, the delay is significantly smaller than in the known sequential mechanisms. If δ₂ is less than δ₁ the parallel processing unit is able to transmit the frame j even before the processing unit 3 can process and transmit this frame. In this example, the decision, whether processing unit 3 or the parallel processing unit 4 should be used to process and transmit the data is based on the current data rate. The switching process to the parallel processing unit 4 is performed, when the data output of the parallel processing unit 4 is smaller than the data output of the processing rate 3. In both cases, no frames will be dropped and therefore the following is true:

t_{λ}=0,λ=0.

With the mechanism according to the invention also the overall adaptation time t_{α} is smaller, since the parallel processing unit 4 can process and transmit data much earlier:

$$\begin{matrix}{t}_{α} = {t}_{0}^{′} + {δ}_{2} - ( {t}_{0} + {δ}_{1} + i Δ t ) \\ = {t}_{0} + [ i \frac{{δ}_{1} + {σ}_{2}}{Δ t} ] Δ t + {δ}_{2} - {t}_{0} - {δ}_{1} - i Δ t \\ = [ \frac{{δ}_{1} + {σ}_{2}}{Δ t} ] Δ t + ( {δ}_{2} - {δ}_{1} )\end{matrix}$$

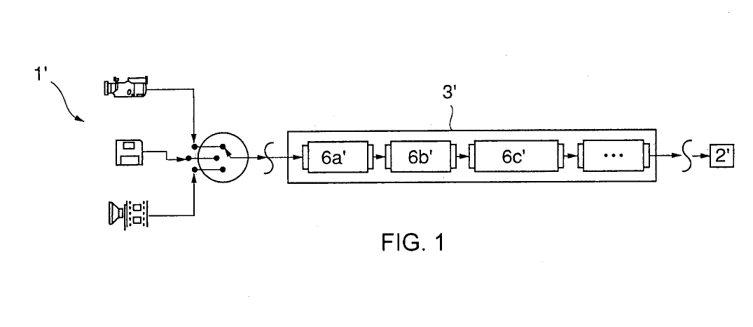

Table 1 shows a comparison between the known mechanism and the mechanism according to the invention for some specific variations. If ideal processing units and parallel processing units can be assumed, which can be initialized immediately and have an intrinsic codec delay of δ=0 ms seconds, each the known mechanism according to FIG. 1 as well as the mechanism according to the invention according to FIG. 3 show the same performance.

TABLE 1

| | | | | Conventional | | Seamless | | | |
|---|---|---|---|---|---|---|---|---|---|
| Chain C₁ | | Chain C₂ | | | Gap | Gap | | Gap | Adaptation |
| Delay | Teardown | Delay | Setup | Lost | Time | Time | Adaptation | Time | Time |
| δ₁ | Φ₁ | δ₂ | Φ₂ | Frames | t_{γ} | t_{γ} | Time | Improvement | Improvement |
| [ms] | [ms] | [ms] | [ms] | λ | [ms] | [ms] | t_{α} [ms] | [ms] | [%] |

Special Case: Perfect Codecs

| | | | | | | | | | |
|---|---|---|---|---|---|---|---|---|---|
| 0 | 0 | 0 | 0 | 0 | 0 | 0 | 0 | 0 | 0 |

Special Case: Low Latency Setup of Chain 2

| | | | | | | | | | |
|---|---|---|---|---|---|---|---|---|---|
| 50 | 200 | 100 | 0 | 7 | 330 | 50 | 130 | 280 | 61 |

Special Case: Low Latency Teardown of Chain 1

| | | | | | | | | | |
|---|---|---|---|---|---|---|---|---|---|
| 50 | 0 | 100 | 200 | 7 | 330 | 50 | 330 | 280 | 0 |

Special Case: Low Delay Codecs

| | | | | | | | | | |
|---|---|---|---|---|---|---|---|---|---|
| 10 | 200 | 10 | 200 | 11 | 440 | 0 | 240 | 440 | 45 |

f = 2.5/s, δt = 40 ms

In the second case, a particular fast setup and adaptation time is assumed, where the codecs exhibit a small delay value and the teardown of the processing unit 3′ requires time. In this case, in the known mechanism seven frames will be dropped, leading to a gap time of t_{γ}=330 ms. With the mechanism according to the invention instead, no frames have to be dropped. The adaptation time is significantly reduced to 130 ms, which is an improvement of 61%.

In the third case, the advantages are shown, that can be achieved, if the processing unit 3 can be de-attached immediately—an unrealistic assumption. In this case, the adaptation cannot be performed faster with the mechanism according to the invention, but the mechanism according to the invention still prevents the dropping of seven frames and the gap time t_{γ} is reduced from 330 to 50 ms.

In the last case, the advantages for codecs with a very small intrinsic delay of approximately 10 ms are shown, which is typical for normal audio codecs. In this case, in the known mechanism eleven frames will be dropped, which is prevented in the mechanism according to the invention. The gap time t_{γ} is reduced from 440 ms to 0 ms the mechanism according to the invention and the adaptation time t_{α} is almost halved.

TABLE 2

| | | | | Conventional | | Seamless | | | |
|---|---|---|---|---|---|---|---|---|---|
| Chain C₁ | | Chain C₂ | | | Gap | Gap | | Gap | Adaptation |
| Delay | Teardown | Delay | Setup | Lost | Time | Time | Adaptation | Time | Time |
| δ₁ | Φ₁ | δ₂ | Φ₂ | Frames | t_{γ} | t_{γ} | Time | Improvement | Improvement |
| [ms] | [ms] | [ms] | [ms] | λ | [ms] | [ms] | t₆₀ [ms] | [ms] | [%] |
| 50 | 100 | 50 | 50 | 5 | 200 | 0 | 120 | 200 | 40 |
| 50 | 100 | 50 | 100 | 7 | 280 | 0 | 160 | 280 | 43 |
| 50 | 100 | 50 | 500 | 17 | 680 | 0 | 560 | 680 | 18 |
| 50 | 100 | 50 | 1000 | 29 | 1160 | 0 | 1080 | 1160 | 7 |
| 50 | 100 | 100 | 50 | 5 | 250 | 50 | 170 | 200 | 32 |
| 50 | 100 | 100 | 100 | 7 | 330 | 50 | 210 | 280 | 36 |
| 50 | 100 | 100 | 500 | 17 | 730 | 50 | 610 | 680 | 16 |
| 50 | 100 | 100 | 1000 | 29 | 1210 | 50 | 1130 | 1160 | 7 |
| 50 | 100 | 200 | 50 | 5 | 350 | 150 | 270 | 200 | 23 |
| 50 | 100 | 200 | 100 | 7 | 430 | 150 | 310 | 280 | 28 |
| 50 | 100 | 200 | 500 | 17 | 830 | 150 | 710 | 680 | 14 |
| 50 | 100 | 200 | 1000 | 29 | 1310 | 150 | 1230 | 1160 | 6 |
| 50 | 200 | 50 | 50 | 8 | 320 | 0 | 120 | 320 | 63 |
| 50 | 200 | 50 | 100 | 9 | 360 | 0 | 160 | 360 | 56 |
| 50 | 200 | 50 | 500 | 19 | 760 | 0 | 560 | 760 | 26 |
| 50 | 200 | 50 | 1000 | 32 | 1280 | 0 | 1080 | 1280 | 16 |
| 50 | 200 | 100 | 50 | 8 | 370 | 50 | 170 | 320 | 54 |
| 50 | 200 | 100 | 100 | 9 | 410 | 50 | 210 | 360 | 49 |
| 50 | 200 | 100 | 500 | 19 | 810 | 50 | 610 | 760 | 25 |
| 50 | 200 | 100 | 1000 | 32 | 1330 | 50 | 1130 | 1280 | 15 |
| 50 | 200 | 200 | 50 | 8 | 470 | 150 | 270 | 320 | 43 |
| 50 | 200 | 200 | 100 | 9 | 510 | 150 | 310 | 360 | 39 |
| 50 | 200 | 200 | 500 | 19 | 910 | 150 | 710 | 760 | 22 |
| 50 | 200 | 200 | 1000 | 32 | 1430 | 150 | 1230 | 1280 | 14 |
| 50 | 400 | 50 | 50 | 13 | 520 | 0 | 120 | 520 | 77 |
| 50 | 400 | 50 | 100 | 14 | 560 | 0 | 160 | 560 | 71 |
| 50 | 400 | 50 | 500 | 24 | 960 | 0 | 560 | 960 | 42 |
| 50 | 400 | 50 | 1000 | 37 | 1480 | 0 | 1080 | 1480 | 27 |
| 50 | 400 | 100 | 50 | 13 | 570 | 50 | 170 | 520 | 70 |
| 50 | 400 | 100 | 100 | 14 | 610 | 50 | 210 | 560 | 65 |
| 50 | 400 | 100 | 500 | 24 | 1010 | 50 | 610 | 960 | 40 |
| 50 | 400 | 100 | 1000 | 37 | 1530 | 50 | 1130 | 1480 | 26 |
| 50 | 400 | 200 | 50 | 13 | 670 | 150 | 270 | 520 | 60 |
| 50 | 400 | 200 | 100 | 14 | 710 | 150 | 310 | 560 | 56 |
| 50 | 400 | 200 | 500 | 24 | 1110 | 150 | 710 | 960 | 36 |
| 50 | 400 | 200 | 1000 | 37 | 1630 | 150 | 1230 | 1480 | 25 |

f = 25/s, Δt = 40 ms, δ₁ = 50 ms

TABLE 3

| | | | | Conventional | | Seamless | | | |
|---|---|---|---|---|---|---|---|---|---|
| Chain C₁ | | Chain C₂ | | | Gap | Gap | | Gap | Adaptation |
| Delay | Teardown | Delay | Setup | Lost | Time | Time | Adaptation | Time | Time |
| δ₁ | Φ₁ | δ₂ | Φ₂ | Frames | t_{γ} | t_{γ} | Time | Improvement | Improvement |
| [ms] | [ms] | [ms] | [ms] | λ | [ms] | [ms] | t_{α} [ms] | [ms] | [%] |
| 100 | 100 | 100 | 50 | 7 | 280 | 0 | 160 | 280 | 43 |
| 100 | 100 | 100 | 100 | 8 | 320 | 0 | 200 | 320 | 38 |
| 100 | 100 | 100 | 500 | 18 | 720 | 0 | 600 | 720 | 17 |
| 100 | 100 | 100 | 1000 | 30 | 1200 | 0 | 1120 | 1200 | 7 |
| 100 | 100 | 200 | 50 | 7 | 380 | 100 | 260 | 280 | 32 |
| 100 | 100 | 200 | 100 | 8 | 420 | 100 | 300 | 320 | 29 |
| 100 | 100 | 200 | 500 | 18 | 820 | 100 | 700 | 720 | 15 |
| 100 | 100 | 200 | 1000 | 30 | 1300 | 100 | 1220 | 1200 | 6 |
| 100 | 200 | 100 | 50 | 9 | 360 | 0 | 160 | 360 | 56 |
| 100 | 200 | 100 | 100 | 10 | 400 | 0 | 200 | 400 | 50 |
| 100 | 200 | 100 | 500 | 20 | 800 | 0 | 600 | 800 | 25 |
| 100 | 200 | 100 | 1000 | 33 | 1320 | 0 | 1120 | 1320 | 15 |
| 100 | 200 | 200 | 50 | 9 | 460 | 100 | 260 | 360 | 43 |
| 100 | 200 | 200 | 100 | 10 | 500 | 100 | 300 | 400 | 40 |
| 100 | 200 | 200 | 500 | 20 | 900 | 100 | 700 | 800 | 22 |
| 100 | 200 | 200 | 1000 | 33 | 1420 | 100 | 1220 | 1320 | 14 |
| 100 | 400 | 100 | 50 | 14 | 560 | 0 | 160 | 560 | 71 |
| 100 | 400 | 100 | 100 | 15 | 600 | 0 | 200 | 600 | 67 |
| 100 | 400 | 100 | 500 | 25 | 1000 | 0 | 600 | 1000 | 40 |
| 100 | 400 | 100 | 1000 | 38 | 1520 | 0 | 1120 | 1520 | 26 |
| 100 | 400 | 200 | 50 | 14 | 660 | 100 | 260 | 560 | 61 |
| 100 | 400 | 200 | 100 | 15 | 700 | 100 | 300 | 600 | 57 |
| 100 | 400 | 200 | 500 | 25 | 1100 | 100 | 700 | 1000 | 36 |
| 100 | 400 | 200 | 1000 | 38 | 1620 | 100 | 1220 | 1520 | 25 |

f = 25/s, Δt = 40 ms, δ₁ = 100 ms

TABLE 4

| | | | | Conventional | | Seamless | | | |
|---|---|---|---|---|---|---|---|---|---|
| Chain C₁ | | Chain C₂ | | | Gap | Gap | | Gap | Adaptation |
| Delay | Teardown | Delay | Setup | Lost | Time | Time | Adaptation | Time | Time |
| δ₁ | Φ₁ | δ₂ | Φ₂ | Frames | t_{γ} | t_{γ} | Time | Improvement | Improvement |
| [ms] | [ms] | [ms] | [ms] | λ | [ms] | [ms] | t_{α} [ms] | [ms] | [%] |
| 200 | 100 | 200 | 50 | 9 | 360 | 0 | 280 | 360 | 22 |
| 200 | 100 | 200 | 100 | 10 | 400 | 0 | 320 | 400 | 20 |
| 200 | 100 | 200 | 500 | 20 | 800 | 0 | 720 | 800 | 10 |
| 200 | 100 | 200 | 1000 | 33 | 1320 | 0 | 1200 | 1320 | 9 |
| 200 | 200 | 200 | 50 | 12 | 480 | 0 | 280 | 480 | 42 |
| 200 | 200 | 200 | 100 | 13 | 520 | 0 | 320 | 520 | 38 |
| 200 | 200 | 200 | 500 | 23 | 920 | 0 | 720 | 920 | 22 |
| 200 | 200 | 200 | 1000 | 35 | 1400 | 0 | 1200 | 1400 | 14 |
| 200 | 400 | 200 | 50 | 17 | 680 | 0 | 280 | 680 | 59 |
| 200 | 400 | 200 | 100 | 18 | 720 | 0 | 320 | 720 | 56 |
| 200 | 400 | 200 | 500 | 28 | 1200 | 0 | 720 | 1120 | 36 |
| 200 | 400 | 200 | 1000 | 40 | 1600 | 0 | 1200 | 1600 | 25 |

f = 25/s, Δt = 40 ms, δ = 200 ms

Tables 2, 3, and 4 do list several different combinations for δ=50, 100, 200 ms, σ=50, 100, 500, 1,000 ms and φ=10, 200, 400 ms. With these tables, advantages of the mechanism according to the invention are again shown clearly. It should be noted in ‘Seamless Mode’ listed in the table, no frames are ever lost.

Regarding further details it is referred to the general description as well as the attached patent claims to avoid repetition.

Finally, it is explicitly pointed out, that the embodiment described above is only intended to describe the invention but does not restrict it to the example.

What is claimed is:

1. Mechanism for the transmission of time-synchronous data from a sender to a receiver using a network, where the data is processed and/or transmitted at the sender as well as the receiver side using at least one first processing unit, wherein a second processing unit parallel to the first processing unit is setup and/or adapted based on changed data rates and/or network characteristics, and that after switching, the processing and/or transmission of data is performed using the second processing unit.

2. Mechanism according to claim 1, wherein the setup and/or adaptation of the second processing is started using a trigger event.

3. Mechanism according to claim 1, wherein the switching is performed after the completion of the setup and/or adaptation of the second processing unit.

4. Mechanism according to claim 1, wherein the switching is performed after reaching a certain switching condition.

5. Mechanism according to claim 4, wherein the certain switching condition is whether at least one given parameter reaches at a predetermined value.

6. Mechanism according to claim 1, wherein the data is processed in the first processing unit using a plurality of subcomponents.

7. Mechanism according to claim 6, wherein the subcomponents includes at least one of a codec, a filter, a packetizer, and a memory buffer.

8. Mechanism according to claim 1, wherein the data is processed in the second processing unit using a plurality of subcomponents.

9. Mechanism according to claim 8, wherein the subcomponents includes at least one of a codec, a filter, a packetizer, and a memory buffer.

10. Mechanism according to one claim 8, wherein the subcomponents are connected during the setup.

11. Mechanism according to claim 1, wherein the first and/or second processing unit is initialized after the setup.

12. Mechanism according to claim 8, wherein each of the subcomponents of the parallel processing unit is adapted to each other, the changed data load and/or changed network characteristics.

13. Mechanism according to claim 6, wherein after the switching process, the subcomponents of the first processing unit are de-attached from each other.

14. Mechanism according to claim 13, wherein: a plurality of the second processing units is setup; and the subcomponents of the first processing unit are included in one of the second processing units.

15. Mechanism according to claim 6, wherein after the switching process, the subcomponents of the first processing unit remain connected.

16. Mechanism according to claim 1, wherein additional second processing units are setup and/or adapted based on changed data load and/or network characteristics.

17. Mechanism according to claim 1, wherein an additional processing unit for the processing and/or transmission of data is used in sequence with the first and/or second processing unit.

18. Mechanism according to claim 1, wherein the data is gathered with one of mechanisms for acquiring visual data and speech data.
